(19) United States
(12) Patent Application Publication
(10) Pub. No.: US 2023/0119972 A1
(43) Pub. Date: Apr. 20, 2023

(54) Methods and Apparatuses of High Throughput Video Encoder

(71) Applicant: MEDIATEK INC., Hsinchu City (TW)

(72) Inventors: Chia-Ming TSAI, Hsinchu City (TW); Chun-Chia CHEN, Hsinchu City (TW); Chih-Wei HSU, Hsinchu City (TW); Tzu-Der CHUANG, Hsinchu City (TW); Ching-Yeh CHEN, Hsinchu City (TW); Yu-Wen HUANG, Hsinchu City (TW)

(21) Appl. No.: 17/577,500

(22) Filed: Jan. 18, 2022

Related U.S. Application Data
(60) Provisional application No. 63/251,066, filed on Oct. 1, 2021.

(51) Int. Cl. H04N 19/147; H04N 19/119; H04N 19/132; H04N 19/105; H04N 19/159; H04N 19/176

(52) U.S. Cl. CPC H04N 19/147; H04N 19/119; H04N 19/132; H04N 19/105; H04N 19/159; H04N 19/176

(57) ABSTRACT

Video encoding methods and apparatuses for performing rate-distortion optimization by a hierarchical architecture include receiving input data associated with a current block in a current picture, determining a block partitioning structure to split the current block into coding blocks and determining a corresponding coding mode for each coding block by multiple Processing Element (PE) groups, and entropy encoding the coding blocks in the current block according to the coding modes determined by the PE groups. Each PE group has parallel PEs and is associated with a particular block size. The parallel PEs in each PE group test a number of coding modes on each partition or sub-partition of the current block to derive rate-distortion costs. The block partitioning structure and corresponding coding modes are then decided based on the rate-distortion costs derived by the PE groups.

### CROSS REFERENCE TO RELATED APPLICATIONS

The present invention claims priority to U.S. Provisional Patent Application Ser. No. 63/251,066, filed on Oct. 1, 2021, entitled “PE-group structure, PE-parallel processing, and scalable mode removal”. The U.S. Provisional Patent application is hereby incorporated by reference in its entirety.

### FIELD OF THE INVENTION

The present invention relates to a hierarchical architecture in video encoders. In particular, the present invention relates to rate-distortion optimization for deciding a block partition structure and corresponding coding modes in video encoding.

### BACKGROUND AND RELATED ART

The Versatile Video Coding (VVC) standard is the latest video coding standard developed by the Joint Collaborative Team on Video Coding (JCT-VC) group of video coding experts from ITU-T Study Group. The VVC standard relies on a block-based coding structure which divides each picture into multiple Coding Tree Units (CTUs). A CTU consists of an N×N block of luminance (luma) samples together with one or more corresponding blocks of chrominance (chroma) samples. For example, each 4:2:0 chroma subsampling CTU consists of one 128×128 luma Coding Tree Block (CTB) and two 64×64 chroma CTBs. Each CTB in a CTU is further recursively divided into one or more Coding Blocks (CBs) in a Coding Unit (CU) for encoding or decoding to adapt to various local characteristics. Flexible CU structures such as the Quad-Tree-Binary-Tree (QTBT) structure may improve the coding performance compared to the Quad-Tree (QT) structure employed in the High-Efficiency Video Coding (HEVC) standard. FIG. 1 illustrates an example of splitting a CTB by the QTBT structure, where the CTB is adaptively partitioned by a quad-tree structure, then each quad-tree leaf node is adaptively partitioned by a binary-tree structure. Binary-tree leaf nodes are denoted as CBs for prediction and transform without further partitioning. In addition to binary-tree partitioning, ternary-tree partitioning may be selected after quad-tree partitioning to capture objects in the center of quad-tree leaf nodes. Horizontal ternary-tree partitioning splits a quad-tree leaf node into three partitions, each of the top and bottom partitions has one quarter of the size of the quad-tree leaf node and the middle partition has a half of the size of the quad-tree leaf node. Vertical ternary-tree partitioning splits a quad-tree leaf node into three partitions, each of the left and right partitions has one quarter of the size of the quad-tree leaf node and the middle partition has a half of the size of the quad-tree leaf node. In this flexible structure, a CTB is first partitioned by a quad-tree structure, then quad-tree leaf nodes are further partitioned by a sub-tree structure which contains both binary and ternary partitions. Sub-tree leaf nodes are denoted as CBs.

The prediction decision in video encoding or decoding is made at the CU level, where each CU is coded by one or a combination of selected coding modes. After obtaining a residual signal generated by the prediction process, the residual signal belong to a CU is further transformed into transform coefficients for compact data representation, and these transform coefficients are quantized and conveyed to the decoder.

A conventional video encoder for encoding video pictures into a bitstream is illustrated in FIG. 2. The encoding processing of the conventional video encoder can be divided into four stages: a pre-processing stage 22, an Integer Motion Estimation (IME) stage 24, a Rate-Distortion Optimization (RDO) stage 26, and an in-loop filtering and entropy coding stage 28. In the RDO stage 26, a single Processing Element (PE) is used to search the best coding mode for encoding a target N×N block within a CTU. A PE is a generic term used to reference a hardware element that executes a stream of instructions to perform arithmetic and logic operations on data. The PE performs scheduled RDO tasks for encoding the target N×N block. The scheduling of a PE is referred to as a PE thread which shows the RDO tasks assigned to the PE in a number of PE calls. The term PE calls or PE run is referred to a fixed time interval for a PE to execute one or more tasks. For example, a first PE thread containing M+1 PE calls is dedicated for a first PE to compute rate and distortion costs for encoding 8×8 blocks by a number of coding modes, and a second PE thread also containing M+1 PE calls is dedicated for a second PE to compute rate and distortion costs for encoding 16×16 blocks by a number of coding modes. In each PE thread, various coding modes are tested by a PE sequentially in order to select best coding modes for block partitions corresponding to the assigned block size. More video coding tools are supported in the VVC standard thus more coding modes need to be tested in each PE thread, causing each PE thread chain in the RDO stage 26 becomes longer. Consequently, it requires longer delay for making the best coding mode decision, and the throughput of the video encoder becomes much lower. Several coding tools introduced in the VVC standard are briefly described in the following.

Merge mode with MVD (MMVD) For a CU coded by the Merge mode, implicitly derived motion information is directly used for prediction sample generation. Merge mode with MVD (MMVD) introduced in the VVC standard further refines a selected Merge candidate by signaling Motion Vector Differences (MVDs) information. A MMVD flag is signaled right after a regular Merge flag to specify whether MMVD mode is used for a CU. MMVD information signaled in the bitstream includes an MMVD candidate flag, an index to specify motion magnitude, and an index for indication of motion direction. In the MMVD mode, one of the first two candidates in the Merge list is selected to be used as the MV basis. An MMVD candidate flag is signaled to specify which one of the first two Merge candidates is used. A distance index specifies motion magnitude information and indicate a pre-defined offset from a starting point. An offset is added to either a horizontal or vertical component of the starting MV. The relation of the distance index and the pre-defined offset is specified in Table 1.

TABLE 1
The relation of distance index and pre-defined offset

| | | | | | | | | |
|---|---|---|---|---|---|---|---|---|
| Distance index | 0 | 1 | 2 | 3 | 4 | 5 | 6 | 7 |
| Offset (in unit | ¼ | ½ | 1 | 2 | 4 | 8 | 16 | 32 |
| of luma samples) | | | | | | | | |

A direction index represents a direction of the MVD relative to the starting point. The direction index indicates one of the four directions along the horizontal and vertical directions. It is noted that the meaning of MVD sign could be variant according to the information of starting MVs. For example, when the staring MV(s) is a uni-prediction MV or bi-prediction MVs with both lists pointing to the same direction of the current picture, the sign shown in Table 2 specifies the sign of the MV offset added to the starting MV. Both lists pointing to the same direction of the current picture if Picture Order Counts (POCs) of two reference pictures are both larger than the POC of the current picture, or POCs of two reference pictures are both smaller than the POC of the current picture. In cases when the starting MVs is bi-prediction MVs with two MVs pointing to different directions of the current picture and the difference of the POCs in list 0 is greater than the one in list 1, the sign in Table 2 specifies the sign of the MV offset added to the list 0 MV component of the starting MV and the sign for the list 1 MV has an opposite sign. Otherwise, when the difference of the POCs in list 1 is greater than the one in list 0, the sign in Table 2 specifies the sign of the MV offset added to the list 1 MV component of the starting MV and the sign for the list 0 MV has an opposite sign. The MVD is scaled according to the difference of POCs in each direction. If the differences of POCs in both lists are the same, no scaling is needed; otherwise, if the difference of POCs in list 0 is larger than the one of list 1, the MVD for list 1 is scaled, by defining the POC difference of List 0 as td and POC difference of List 1 as tb. If the POC difference of List 1 is greater than List 0, the MVD for list 0 is scaled in the same way. If the starting MV is uni-predicted, the MVD is added to the available MV.

TABLE 2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

Bi-prediction with CU-level Weight (BCW) A bi-prediction signal is generated by averaging two prediction signals obtained from two different reference pictures and/or using two different motion vectors in the HEVC standard. In the VVC standard, the bi-prediction mode is extended beyond simple averaging to allow weighted averaging of the two prediction signals.

P_{bi-pred}((8−w)*P₀+w*P₁+4)>>3

In the VVC standard, five weights w ∈{−2, 3, 4, 5, 10} are allowed in the weighted averaging bi-prediction. In each bi-predicted cu, the weight w is determined in one of two ways: 1) for a non-Merge CU, the weight index is singled after the motion vector difference; 2) for a Merge CU, the weight index is inferred from neighboring blocks based on the Merge candidate index. BCW is only applied to CUs with 256 or more luma samples, which implies the CU width times the CU height must be greater than or equal to 256. For low-delay pictures, all 5 weights are used. For non-low-delay pictures, only 3 weights w∈{3, 4, 5} are used.

Fast search algorithms are applied to find the weight index without significantly increasing the encoder complexity at the video encoders. When combined with Adaptive Motion Vector Resolution (AMVR), unequal weights are only conditionally checked for 1-pel and 4-pel motion vector precisions if the current picture is a low-delay picture. When BCM is combined with the affine mode, affine Motion Estimation (ME) is performed for unequal weights only if the affine mode is selected as the current best mode. Unequal weights are only conditionally checked when the two reference pictures in bi-prediction are the same. Unequal weights are not searched when certain conditions are met, depending on the POC distance between the current picture and its reference pictures, the coding QP, and the temporal level.

The BCW weight index is coded using one context coded bin followed by bypass coded bins. The first context coded bin indicates if equal weight is used; and if unequal weight is used, additional bins are signaled using bypass coding to indicate which unequal weight is used. Weighted Prediction (WP) is a coding tool supported by the H.264/AVC and HEVC standards to efficiently code video content with fading. Support for WP was also added into the VVC standard. WP allows weighting parameters (weight and offset) to be signaled for each reference picture in each of the reference picture lists L0 and L1. The weight(s) and offset(s) of the corresponding reference picture(s) are applied during motion compensation. WP and BCW are designed for different types of video content. In order to avoid interactions between WP and BCW, which will complicate the VVC decoder design, if a CU uses WP, then the BCW weight index is not signaled, and w is inferred to be 4, implying equal weight is applied. For a Merge CU, the weight index is inferred from neighboring blocks based on the Merge candidate index. This can be applied to both normal Merge mode and inherited affine Merge mode. For constructed affined Merge mode, the affine motion information is constructed based on the motion information of up to 3 blocks. The BCW index for a CU using the constructed affine Merge mode is simply set equal to the BCW index of the first control point MV. In the VVC standard, Combined Inter and Intra Prediction (CIIP) and BCW cannot be jointly applied for a CU. When a CU is coded with the CIIP mode, the CBW index of the current CU is set to 4, implying equal weight is applied.

Multiple Transform Selection (MTS) for Core Transform In addition to DCT-II transforming which has been employed in the HEVC standard, a MTS scheme is used for residual coding both inter and intra coded blocks. It provides the flexibility to select a transform coding setting from multiple transforms such as DCT-II, DCT-VIII, and DST-VII. The newly introduced transform matrices are DST-VII and DCT-VIII. Table 3 shows the basic functions of DST and DCT transform.

TABLE 3
Transform basis functions of DCT-II/VIII and DSTVII for N-point input

| Transform Type | Basis function Tᵢ(j), i, j = 0, 1, . . . , N-1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In order to keep the orthogonality of the transform matrix, the transform matrices are quantized more accurately than the transform matrices in the HEVC standard. To keep the intermediate values of the transformed coefficients within the 16-bit range, after horizontal and after vertical transform, all the coefficients are 10-bit coefficients. In order to control the MTS scheme, separate enabling flags are specified at the Sequence Parameter Set (SPS) level for intra and inter prediction, respectively. When MTS is enabled at the SPS, a CU level flag is signaled to indicate whether MTS is applied or not. MTS is applied only for the luma component. The MTS signaling is skipped when one of the below conditions is applied. The position of the last significant coefficient for the luma Transform Block (TB) is less than 1 (i.e., DC only); the last significant coefficient of the luma TB is located inside the MTS zero-out region.

If the MTS CU flag is equal to zero, then DCT-II is applied in both directions. However, if the MTS CU flag is equal to one, then two other flags are additionally signaled to indicate the transform type for the horizontal and vertical directions, respectively. A transform and flags signaling mapping table is shown in Table 4. Unified the transform selection for Intra Sub-Partition (ISP) and implicit MTS is used by removing the intra-mode and block-shape dependencies. If a current block is coded in ISP mode or if the current block is an intra block and both intra and inter explicit MTS is on, then only DST-VII is used for both horizontal and vertical transform cores. When it comes to transform matrix precision, 8-bit primary transform cores are used. Therefore, all the transform cores used in the HEVC standard are kept as the same, including 4-point DCT-II and DST-VII, 8-point, 16-point and 32-point DCT-II. Also, other transform cores including 64-point DCT-II, 4-point DCT8, 8-point, 16-point, 32-point DST-VII and DCT-VIII, use 8-bit primary transform cores.

TABLE 4
Transform and flags signaling mapping table

| MTS CU | MTS Horizontal | MTS Vertical | Intra/inter | |
|---|---|---|---|---|
| flag | flag | flag | Horizontal | Vertical |
| 0 | | | DCT-II | |
| 1 | 0 | 0 | DST-VII | DST-VII |
| | 0 | 1 | DCT-VIII | DST-VII |
| | 1 | 0 | DST-VII | DCT-VIII |
| | 1 | 1 | DCT-VIII | DCT-VIII |

To reduce the complexity of large size DST-VII and DCT-VIII, High frequency transform coefficients are zeroed out for the DST-VII and DCT-VIII blocks with size (width or height, or both width and height) equal to 32. Only the coefficients within the 16×16 lower-frequency region are retained.

As in the HEVC standard, the residual of a block can be coded with transform skip mode. To avoid the redundancy of syntax coding, the transform skip flag is not signalled when the CU level MTS CU flag is not equal to zero. Note that implicit MTS transform is set to DCT-II when Low-Frequency Non-Separable Transform (LFNST) or Matrix-based Intra Prediction (MIP) is activated for the current CU. Also the implicit MTS can be still enabled when MTS is enabled for inter coded blocks.

Geometric Partitioning Mode (GPM) In the VVC standard, the GPM is supported for inter prediction. The GPM is signaled using a CU-level flag as one kind of Merge mode, with other Merge modes including the regular Merge mode, the MMVD mode, the CCIP mode, and the subblock Merge mode. In total, 64 partitions are supported by GPM for each possible CU size w×h=2^{m}×2ⁿ with m, n ∈{3 . . . 6} excluding 8×64 and 64×8. When this mode is used, a CU is split into two parts by a geometrically located straight line as shown in FIG. 3. The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that only two motion compensated predictors are computed for each CU, which is the same as the conventional bi-prediction.

If geometric partitioning mode is used for the current CU, then a geometric partition index indicating the partition mode of the geometric partition (angle and offset), and two Merge indices (one for each partition) are further signaled. The number of maximum GPM candidate size is signaled explicitly in the SPS and specifies syntax binarization for GPM merge indices. After predicting each part of the geometric partition, the sample values along the geometric partition edge are adjusted using a blending processing with adaptive weights to acquire the prediction signal for the whole CU. Transform and quantization process will be applied to the whole CU as in other prediction modes. Finally, the motion field of a CU predicted using the geometric partition modes is stored.

The uni-prediction candidate list is derived directly from the Merge candidate list constructed according to the extended Merge prediction process. Denote n as the index of the uni-prediction motion in the geometric uni-prediction candidate list. The LX motion vector of the n-th extended Merge candidate, with X equal to the parity of n, is used as the n-th uni-prediction motion vector for geometric partitioning mode. For example, the uni-prediction motion vector for Merge index 0 is L0 MV, the uni-prediction motion vector for Merge index 1 is L1 MV, the uni-prediction motion vector or Merge index 2 is L0 MV, and the uni-prediction motion vector for Merge index 3 is L1 MV. In case a corresponding LX motion vector of the n-the extended merge candidate does not exist, the L(1−X) motion vector of the same candidate is used instead as the uni-prediction motion vector for geometric partitioning mode.

After predicting each part of a geometric partition using its own motion, blending is applied to the two prediction signals to derive samples around the geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j}$$

$${ρ}_{j} = {ρ}_{x , j} cos ( {φ}_{i} ) + {ρ}_{y , j} sin ( {φ}_{i} )$$

$${ρ}_{x , j} = \{ \begin{matrix}0 & i \% 16 = 8 or ( i \% 16 \neq 0 and h \geq w \\ \pm ( j \times w ) ≫ 2 & otherwise\end{matrix}$$

$${ρ}_{y , j} = \{ \begin{matrix}\pm ( j \times w ) ≫ 2 & i \% 16 = 8 or ( i \% 16 \neq 0 and h \geq w \\ 0 & otherwise\end{matrix}$$

where i, j are the indices for angle and offset of a geometric partition, which depend on the signaled geometric partition index. The sign of ρ_{x,j} and ρ_{y,j} depend on angle index i.
The weights for each part of a geometric partition are derived as following:

$$wIdxL ( x , y ) = part Idx ? 32 + d ( x , y ) : 32 - d ( x , y )$$

$${w}_{0} ( x , y ) = \frac{Clip 3 ( 0 , 8 , ( wIdxL ( x , y ) + 4 ) ≫ 3 )}{8}$$

$${w}_{1} ( x , y ) = 1 - {w}_{0} ( x , y )$$

The partIdx depends on the angle index i.

Mv1 from the first part of the geometric partition, Mv2 from the second part of the geometric partition and a combined motion vector of Mv1 and Mv2 are stored in the motion field of a geometric partitioning mode coded CU. The stored motion vector type for each individual position in the motion field are determined as:

sType=abs(motionIdx)<32?2:(motionIdx≤0?(1−partIdx):partIdx)

where motionIdx is equal to d(4x+2, 4y+2), which is recalculated from the above equation. The partIdx depends on the angle index i. If sType is equal to 0 or 1, Mv0 or Mv1 are stored in the corresponding motion field, otherwise if sType is equal to 2, a combined motion vector from Mv0 and Mv2 are stored. The combined motion vector is generated using the following process: if Mv1 and Mv2 are from different reference picture lists (one from L0 and the other from L1), then Mv1 and Mv2 are simply combined to form bi-prediction motion vectors; otherwise, if Mv1 and Mv2 are from the same list, only the uni-prediction motion Mv2 is stored.

Combined Inter and Intra Prediction (CIIP) In the VVC standard, when a CU is coded in Merge mode, if the CU contains at least 64 luma samples (that is, CU width times CU height is equal to or larger than 64), and if both CU width and CU height are less than 128 luma samples, an additional flag is signaled to indicate if the Combined Inter and Intra Prediction (CIIP) mode is applied to the current CU. As the name suggested, the CIIP mode combines an inter prediction signal with an intra prediction signal. The inter prediction signal in the CIIP mode Pᵢₙₜₑᵣ is derived using the same inter prediction process applied to the regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks as follows. A variable isIntraTop is set to 1 if the top neighboring block is available and intra coded, otherwise isIntraTop is set to 0, and a variable isIntraLeft is set to 1 if the left neighboring block is available and intra coded, otherwise isIntraLeft is set to 0. The weight value wt is set to 3 if the sum of the two variables isIntraTop and isIntraLeft is equal to 2, otherwise the weight value wt is set to 2 if the sum of the two variables is equal to 1; otherwise the weight value wt is set to 1. The CIIP prediction is calculated as follows:

P_{CIIP}=((4−wt)*Pᵢₙₜₑᵣ+wt*Pᵢₙₜᵣₐ+2)>>2

### BRIEF SUMMARY OF THE INVENTION

Embodiments of video encoding methods for a video encoding system perform Rate Distortion Optimization (RDO) by a hierarchical architecture. The embodiments of video encoding methods comprise receiving input data associated with a current block in a video picture, determining a block partitioning structure of the current block and determining a corresponding coding mode for each coding block in the current block by multiple Processing Element (PE) groups, splitting the current block into one or more coding blocks according to the block partitioning structure, and entropy encoding the coding blocks in the current block according to the corresponding coding modes determined by the PE groups. Each PE group has multiple parallel PEs performing RDO tasks. Each PE group is associated with a particular block size, and for each PE group, the current block is divided into one or more partitions each having the particular block size associated with the PE group and each partition is divided into sub-partitions according to one or more partitioning types. The parallel PEs of each PE group test multiple coding modes on each partition of the current block and corresponding sub-partitions split from each partition to derive rate-distortion costs associated with the coding modes on each partition and sub-partition. The block partitioning structure of the current block and the corresponding coding mode for each coding block in the current block are decided according to the rate-distortion costs.

In some embodiments of the hierarchical architecture, a buffer size required for each PE group is related to the particular block size associated with the PE group. For example, a smaller memory buffer is required for PE groups associated with smaller block sizes. The buffer size required for each PE group may be further reduced by setting a same block partitioning testing order for all PE threads in the PE group, and based on rate-distortion costs associated with at least two partitioning types, a set of reconstruction buffer initially storing reconstruction samples associated with one of the two partitioning types is released for storing reconstruction samples associated with another partitioning type. For example, the block partitioning testing order for all PE threads is horizontal binary-tree partitioning, vertical binary-tree partitioning, and no-split. The partitioning types for dividing each partition in the current block into sub-partitions include one or a combination of horizontal binary-tree partitioning, vertical binary-tree partitioning, horizontal ternary-tree partitioning, and vertical ternary-tree partitioning according to some embodiments.

A PE in a PE group is used to test a coding mode or one or more candidates of a coding mode in one PE call, or a PE tests a coding mode or a candidates of a coding mode in multiple PE calls. A PE call is a time interval. A PE computes a low-complexity RDO operation followed by a high-complexity RDO operation in a PE call or a PE computes a low-complexity RDO operation or a high-complexity RDO operation in a PE call. In some embodiments, a first PE in a PE group computes a low-complexity RDO operation of a coding mode and a second PE in the same PE group computes a high-complexity RDO operation of the coding mode, and intermediate results can be pass from the first PE to the second PE. For example, the two PEs test a coding mode on first and second partitions, where the first PE computes the low-complexity RDO operation for the second partition while the second PE computes the high-complexity RDO operation for the first partition.

In some preferred embodiments, coding tools or coding modes with similar properties are combined in a same PE thread in each PE group. In some embodiments, one or more predefined conditions are checked for one or more PE groups, and the video encoding system adaptively selects coding modes for one or more PEs when the predefined conditions are satisfied. The predefined conditions may be associated with comparisons of information between the partition/sub-partition and one or more neighboring blocks of the partition/sub-partition, a current temporal identifier, historical Motion Vector (MV) list, or preprocessing results. The information between the partition/sub-partition and one or more neighboring blocks of the partition/sub-partition comprises a prediction mode, block size, block partition type, MVs, reconstruction samples, or residuals. In an embodiment, one or more PEs skip coding in one or more PE calls when the predefined conditions are satisfied. For example, one of the predefined conditions is satisfied when an accumulated rate-distortion cost of one PE is higher than each of accumulated rate-distortion costs of other PEs by a predefined threshold.

In some embodiments, one or more buffers are shared among the parallel PEs of a same PE group by unifying a data scanning order among the PEs. A current PE of a current PE group may share prediction samples from one or more PEs of the current PE group directly without temporary storing the prediction samples in a buffer. In one embodiment, the current PE tests one or more GPM candidates on each partition or sub-partition by acquiring the prediction samples form the one or more PEs testing Merge candidates on the partition or sub-partition. GPM tasks originally assigned to the current PE may be adaptively skipped according to a rate-distortion cost associated with a prediction result of the current PE. In another embodiment, the current PE tests one or more CIIP candidates on each partition or sub-partition by acquiring the prediction samples from one or more PEs testing Merge candidates on the partition or sub-partition and one PE testing an intra Plannar mode. CITP tasks originally assigned to the current PE may be adaptively skipped according to a rate-distortion cost associated with a prediction result of the current PE. In yet another embodiment, the current PE tests one or more AMVP-BI candidates on each partition or sub-partition by acquiring the prediction samples from the one or more PEs testing AMVP-UNI candidates on the partition or sub-partition. In one embodiment, the current PE tests one or more BCW candidates on each partition or sub-partition by acquiring the prediction samples form the one or more PEs testing AMVP-UNI candidates on the partition or sub-partition.

According to an embodiment, a set of neighboring buffer storing neighboring reconstruction samples is shared between multiple PEs in one PE group. In one embodiment, residual of each coding block is generated and the residual is shared between multiple PEs for transform processing according to different transform coding settings. In some embodiments of the present invention, Sum of Absolute Transform Difference (SATD) units are dynamically shared among the parallel PEs within one PE group.

Aspects of the disclosure further provide an apparatus for a video encoding system. The apparatus comprising one or more electronic circuits configured for receiving input data associated with a current block in a video picture, determining a block partitioning structure of the current block and determining a corresponding coding mode for each coding block in the current block by multiple PE groups, splitting the current block into one or more coding blocks according to the block partitioning structure, and entropy encoding the coding blocks in the current block according to the corresponding coding modes determined by the PE groups. Each PE group has multiple parallel PEs. Each PE group is associated with a particular block size, and for each PE group, the current block is divided into one or more partition each having the particular block size and each partition is divided into sub-partitions according to one or more partitioning types. The parallel PEs of each PE group test multiple coding modes on each partition of the current block and corresponding sub-partitions split from each partition. The block partitioning structure of the current block and the corresponding coding mode of each coding block are decided according to rate-distortion costs associated with the coding modes tested by the PE groups.

### BRIEF DESCRIPTION OF THE DRAWINGS

Various embodiments of this disclosure that are proposed as examples will be described in detail with reference to the following figures, wherein like numerals reference like elements, and wherein:

FIG. 1 illustrates an example of splitting a CTB by a QTBT structure.

FIG. 2 illustrates video encoding processing employing a single PE for testing each block size according to a conventional video encoder.

FIG. 3 illustrates examples of GPM partitioning grouped by identical angles.

FIG. 4 illustrates video encoding processing with a RDO stage having parallel PEs in each PE group according to an embodiment of the present invention.

FIG. 5 illustrates an exemplary timing diagram of a PE processing low-complexity RDO and a PE processing high-complexity RDO for three different partition types of a 128×128 block.

FIG. 6 demonstrates a timing diagram for the first two PE groups of the RDO stage in a hierarchical architecture according to an embodiment of the present invention.

FIG. 7 illustrates an embodiment of adaptively selecting coding modes for a PE according to predefined conditions.

FIG. 8 illustrates an embodiment of sharing source sample buffer and neighboring buffer among PEs in the same PE group.

FIG. 9 illustrates an embodiment of directly passing prediction samples between parallel PEs in a PE group for generating GPM predictors.

FIG. 10 illustrates an embodiment of directly passing prediction samples between parallel PEs in a PE group for generating CIIP predictors.

FIG. 11 illustrates an embodiment of directly passing prediction samples between parallel PEs in a PE group for generating bi-directional AMVP predictors.

FIG. 12A illustrates an embodiment of directly passing prediction samples between parallel PEs in a PE group for generating BCW predictors.

FIG. 12B illustrates another embodiment of directly passing prediction samples between parallel PEs in a PE group for generating BCW predictors.

FIG. 13 illustrates an embodiment of sharing a buffer of neighboring reconstruction samples between different PEs in the parallel PE architecture.

FIG. 14 illustrates an embodiment of on the fly terminating processing of some PEs for power saving in the parallel PE architecture.

FIG. 15 illustrates an embodiment of residual sharing for different transform coding settings in the parallel PE architecture.

FIG. 16 illustrates an embodiment of sharing SATD units between PEs in the parallel PE architecture.

FIG. 17 is a flowchart of encoding video data of a CTB by multiple PE groups each having parallel PEs according to an embodiment of the present invention.

FIG. 18 illustrates an exemplary system block diagram for a video encoding system incorporating one or a combination of high throughput video processing methods according to embodiments of the present invention.

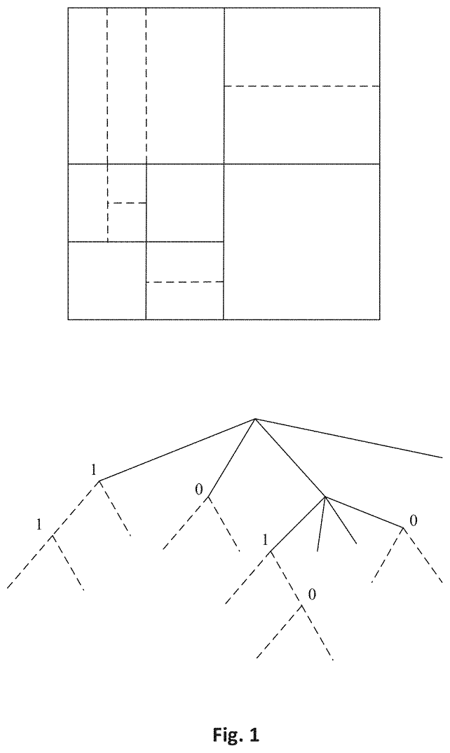

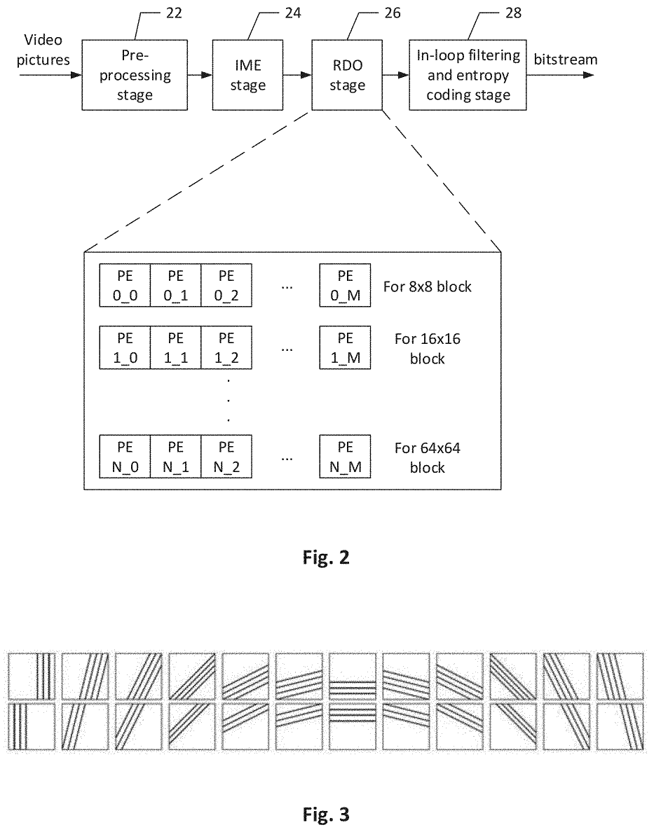

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “an embodiment”, “some embodiments”, or similar language means that a particular feature, structure, or characteristic described in connection with the embodiments may be included in at least one embodiment of the present invention. Thus, appearances of the phrases “in an embodiment” or “in some embodiments” in various places throughout this specification are not necessarily all referring to the same embodiment, these embodiments can be implemented individually or in conjunction with one or more other embodiments. Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

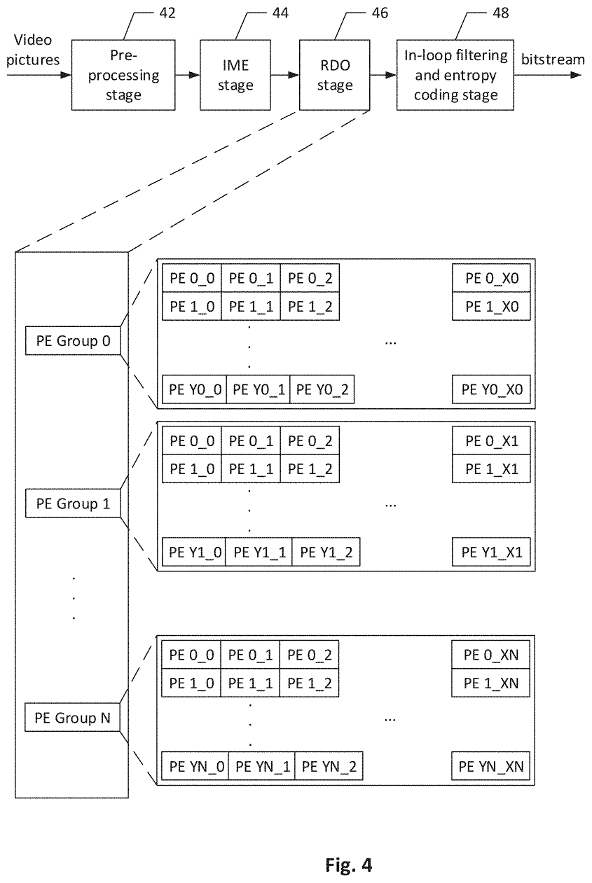

High Throughput Video Encoder FIG. 4 illustrates a high throughput video encoder having a hierarchical architecture for data processing in the RDO stage according to an embodiment of the present invention. The encoding processing of the high throughput video encoder is generally divided into four encoding stages: pre-processing stage 42, IME stage 44, RDO stage 46, and in-loop filtering and entropy coding stage 48. Data in video pictures are sequentially processed in the pre-processing stage 42, IME stage 44, RDO stage 46, and in-loop filtering and entropy coding stage 48 to generate a bitstream. A common motion estimation architecture consists of Integer Motion Estimation (IME) and Fraction Motion Estimation (FME), where IME performs integer pixel search over a large area and FME performs sub-pixel search around the best selected integer pixel. Multiple PE groups in the RDO stage 46 are used to determine a block partitioning structure of a current block and these PE groups are also used to determine a corresponding coding mode for each coding block in the current block. The video encoder splits the current block into one or more coding blocks according to the block partitioning structure and encodes each coding block according to the coding mode decided by the RDO stage 46. In the RDO stage 46, each PE group has multiple parallel PEs and each PE processes RDO tasks assigned in a PE thread. Each PE group sequentially computes rate-distortion performance of coding modes tested on one or more partitions each having a particular block size and sub-partitions added up to the particular block size. For each PE group, a current block is divided into one or more partitions each having the particular block size associated with the PE group and each partition is divided into sub-partitions according to one or more partitioning types. For example, each partition is divided into sub-partitions by two partitioning types including horizontal binary-tree partitioning and vertical binary-tree partitioning. In some embodiments, the partition and sub-partitions for a first PE group include the 128×128 partition, top 128×64 sub-partition, bottom 128×64 sub-partition, left 64×128 sub-partition, and 128×64 sub-partition. In another example, each partition is divided into sub-partitions by four partitioning types including horizontal binary-tree partitioning, vertical binary-tree partitioning, horizontal ternary-tree partitioning, and vertical ternary-tree partitioning. A PE in each PE group tests various coding modes on each partition of the current block having the particular block size and corresponding sub-partitions split from each partition. A best block partitioning structure for the current block and best coding modes for the coding blocks are consequently decided according to rate-distortion costs associated with the tested coding modes in the RDO stage 46.

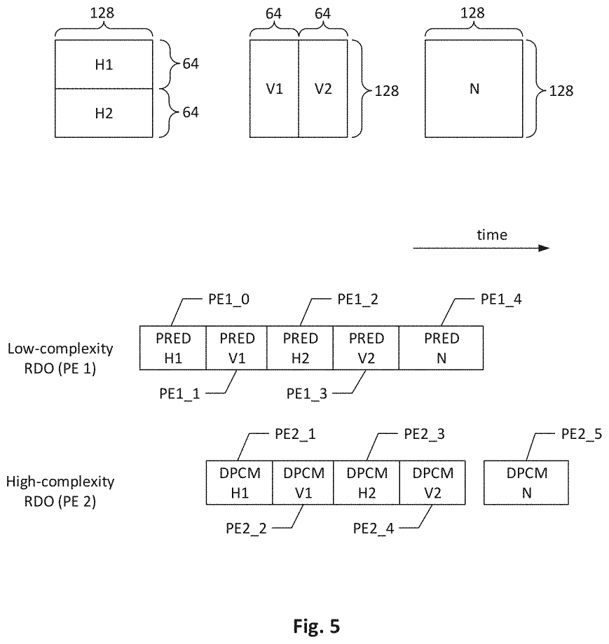

Each PE tests a coding mode or one or more candidates of a coding mode in a PE call, or each PE tests a coding mode or a candidates of a coding mode in multiple PE calls. The PE call is a time interval. The required buffer size of PEs in each PE group may be further optimized according to the particular block size associated with the PE group. For each coding mode or each candidate of a coding mode, video data in a partition or sub-partition may be computed by a low-complexity Rate Distortion Optimization (RDO) operation followed by a high-complexity RDO operation. The low-complexity RDO operation and high-complexity RDO operation of a coding mode or a candidate of a coding mode may be computed by one PE or multiple PE. FIG. 5 illustrates an exemplary timing diagram of data processing in a first PE and a second PE of PE group 0. In this example, the first and second PEs are assigned to test normal inter candidate modes, where prediction is performed in the low-complexity RDO operation by the first PE while Differential Pulse Code Modulation (DPCM) is performed in the high-complexity RDO operation by the second PE. In the example as shown in FIG. 5, PE group 0 is associated with a 128×128 block allowing two possible partitioning types. The 128×128 block may be divided into two horizontal sub-partitions H1 and H2 by horizontal binary-tree partitioning or two vertical sub-partitions V1 and V2 by vertical binary-tree partitioning, or the 128×128 block is not split. In FIG. 5, the task computed in each PE call by a first PE is a low-complexity RDO operation (e.g. PE1_0) and the task computed in each PE call by a second PE is a high-complexity RDO operation (e.g. PE2_1). The first PE in PE group 0 predicts the first horizontal binary-tree sub-partition H1 by a normal inter candidate mode at PE call PE1_0, and predicts the first vertical binary-tree sub-partition V1 by the normal inter candidate mode at PE call PE1_1. The first PE predicts the second horizontal binary-tree sub-partition H2 by the normal inter candidate mode at PE call PE1_2, and predicts the second vertical binary-tree sub-partition V2 by the normal inter candidate modes at PE call PE1_3. The first PE predicts the non-split partition N by the normal inter candidate mode at PE call PE1_4. The second PE performs DPCM on the first horizontal binary-tree sub-partition H1 at PE call PE2_1, and performs DPCM on the first vertical binary-tree sub-partition V1 at PE call PE2_2. The second PE performs DPCM on the second horizontal binary-tree sub-partition H2 at PE call PE2_3, performs DPCM on the second vertical binary-tree sub-partition V2 at PE call PE2_4, and performs DPCM on the non-split partition N at PE call PE2_5. In this example, the high-complexity RDO operation performed by the second PE is executed in parallel processing with the low-complexity RDO of a subsequent partition/sub-partition. For example, after processing the low-complexity RDO operation of a current partition at PE call PE1_0, the high-complexity RDO operation of the current partition at PE call PE2_1 is processed in parallel with the low-complexity RDO operation of a subsequent partition at PE call PE1_1.

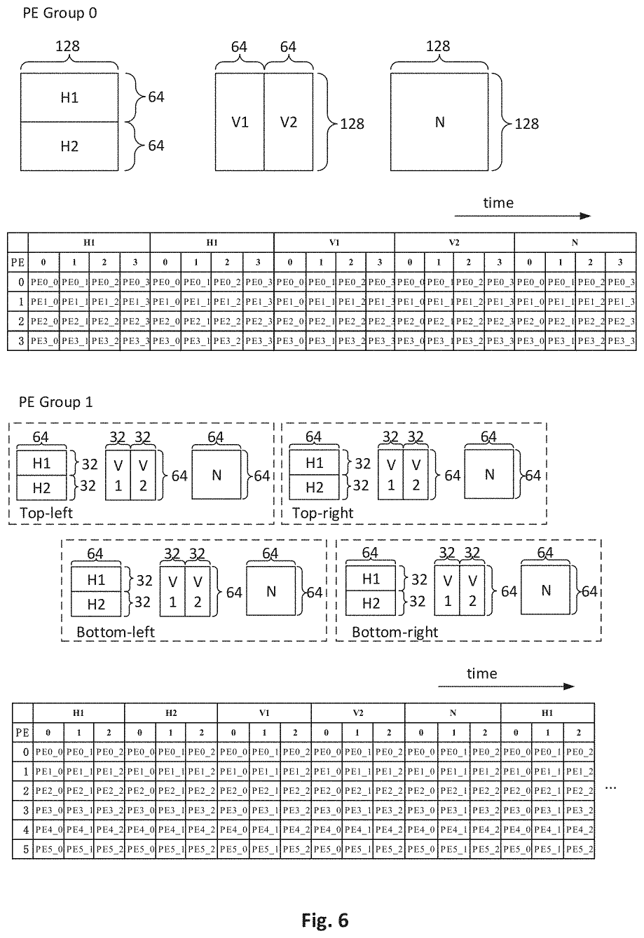

FIG. 6 demonstrates an embodiment of the hierarchical architecture for the RDO stage employing multiple PEs in PE group 0 and PE group 1 for processing 128×128 CTUs. PE group 0 is used for calculating rate distortion performance of various coding modes applied to a non-split 128×128 partition and sub-partitions split from the 128×128 partition. PE group 0 determines best coding modes corresponding to the best block partitioning structure among the non-split 128×128 partition, two 128×64 sub-partitions, and two 64×128 sub-partitions. In this embodiment, the block partition testing order in PE group 0 is horizontal binary-tree sub-partitions H1 and H2, vertical binary-tree sub-partitions V1 and V2, then the non-split partition N. Four PEs are assigned in PE group 0 in this embodiment, where each PE is used to evaluate the rate-distortion performance of one or more corresponding coding modes applied on the 128×128 partition and the sub-partitions. For example, the coding modes evaluated by the four PE are normal inter mode, Merge mode, Affine mode, and intra mode respectively. In each PE thread in PE group 0, four PE calls are used to apply a corresponding coding mode to each partition or sub-partition in order to compute the rate-distortion performance. The best coding mode(s) and the best block partitioning structure of PE group 0 are selected by comparing the rate-distortion costs in the four PE threads. Similarly, PE group 1 is used for testing the rate-distortion performance of various coding modes applied to four 64×64 partitions of the 128×128 CTU and sub-partitions split from the four 64×64 partitions. In this embodiment, the block partition testing order in PE group 1 is the same as the one in PE group 0, however, there are six parallel PEs used to evaluate the rate-distortion performance of the corresponding coding modes applied to the 64×64 partitions, 64×32 sub-partitions, and 32×64 sub-partitions. In each PE thread of PE group 1, three PE calls are used to apply a corresponding coding mode to each partition or sub-partition. The best coding modes and the best block partitioning structure of PE group 1 are selected by comparing the rate-distortion costs of the six PE threads. Beside PE group 0 and PE group 1 shown in FIG. 6, there are also PE groups in the RDO stage used to test a number of coding modes on other block sizes. A best block partitioning structure for each CTU and best coding modes for the coding blocks within the CTU are selected according to the lowest combined rate-distortion costs computed by the PE groups. For example, if a combined rate-distortion cost is the lowest when combining rate-distortion costs corresponding to a Merge candidate applied to a 64×128 left horizontal sub-partition H1 in PE group 0, a CIIP candidate applied to a 64×64 non-spilt partition N at the top-right of the CTU in PE group 1, and an affine candidate applied to a 64×64 non-split partition N at the bottom-right of the CTU in PE group 1, then the best block partitioning structure of the CTU is first split by vertical binary-tree partitioning, then the right binary-tree partition is further split by horizontal binary-tree partitioning. The resulting coding blocks in the CTU are one 64×128 coding block and two 64×64 coding blocks, and the corresponding coding modes used to encode these coding blocks are Merge, CIIP, and affine modes respectively.

In various embodiments of the high throughput video encoder, since more than one parallel PE is employed in each PE group to shorten the original PE thread chain of the PE group, the encoder latency of the PE groups is reduced while maintaining the supreme rate-distortion performance. The high throughput video encoder of the present invention increases the encoder throughput to be capable of supporting Ultra High Definition (UHD) video encoding. The required buffer sizes of PEs in various embodiments of the hierarchical architecture can be optimized according to the particular block size of each PE group. Each PE group is designed to process a particular block size, the required buffer size for each PE group is related to the corresponding particular block size. For example, a smaller buffer is used for PEs of a PE group processing smaller size blocks. In the embodiment as shown in FIG. 6, the buffer size for PE group 0 is determined by considering the buffer size needed for processing 128×128 blocks, and the buffer size for PE group 1 is determined by only considering the buffer size needed for processing 64×64 blocks. The required buffer sizes for the PE groups can be optimized according to the particular block size associated with each PE group because each PE group only conducts mode decision for partitions having the particular size or sub-partitions added up to the particular block size. The required buffer size for each PE group can be further reduced by setting a same block partitioning testing order for all PEs in the PE group, for example, the order in PE group 0 is horizontal binary-tree partitioning, vertical binary-tree partitioning, then non-split. Theoretically, three sets of reconstruction buffer are required to store reconstruction samples corresponding to the three block partitioning types. However, only two sets of reconstruction buffer are needed when the non-split partition is tested after testing the horizontal binary-tree sub-partitions and vertical binary-tree sub-partitions. One set of the reconstruction buffer is initially used to store the reconstruction samples of the horizontal binary-tree sub-partitions and another set of the reconstruction buffer is initially used to store the reconstruction samples of the vertical binary-tree sub-partitions. A better binary-tree partitioning type corresponding to a lower combined rate-distortion cost is selected, and the reconstruction buffer set originally storing the reconstruction samples of the binary-tree sub-partitions having a higher combined rate-distortion cost is released. When processing the non-split partition, the reconstruction samples of the non-split partition can be stored in the released reconstruction buffer. For further consideration of coding throughput improvement and hardware resource optimization regarding the RDO stage architecture, the following methods implemented in the proposed hierarchical architecture are provided in the present disclosure.

Method 1: Combine Coding Tools or Coding Modes with Similar Properties in a PE Thread Some embodiments of the present invention further reduce the necessary resources required while enhancing the encoding throughput by combining coding tools or coding modes with similar properties in the same PE thread. Table 5 shows the coding modes tested by six PEs in a PE group according to an embodiment of combining coding tools or coding modes with similar properties in the same PE thread. Call 0, Call 1, Call 2, and Call 3 represent four PE calls of a PE thread in a sequential order for processing a current partition or sub-partition within a CTB. Each PE thread is scheduled to test dedicated one or more of coding tools, coding modes and candidates in each PE call. In this embodiment, the first PE tests normal inter candidate modes to encode a current partition or sub-partition, where uni-prediction candidates are tested followed by bi-prediction candidates. The second PE encodes the current partition or sub-partition by intra angular candidate modes. The third PE encodes the current partition or sub-partition by Affine candidate modes, and the fourth PE encodes the current partition or sub-partition by MMVD candidate modes. The fifth PE applies GEO candidate modes and the sixth PE applies inter Merge candidate modes to encode the current partition or sub-partition. As shown in Table 5, similar property coding tools or coding modes are combined together in the same PE thread, for example, the evaluation of inter Merge modes could be put in PE thread 1 and the evaluation of Affine modes could be put in PE thread 3. If similar property coding tools or coding modes are not put in the same PE thread, each PE needs to have more hardware circuits to support variety of coding tools. For example, if some of the MMVD candidate modes are tested by PE 1 while some MMVD candidate modes are tested by PE 4, two sets of MMVD hardware circuits are required in hardware implementation, one for PE 1, another for PE 4. Only one set of MMVD hardware circuits is required for PE 4 if all MMVD candidate modes are tested by PE 4 as shown in Table 5. According to the embodiment shown in Table 5, similar property coding tools or coding modes are arranged to be executed by the same PE thread such as Affine related coding tools are all put in PE thread 3, MMVD related coding tools are all put in PE thread 4, and GEO related coding tools are all put in PE thread 5.

TABLE 5

| PE | Call 0 | Call 1 | Call 2 | Call 3 |
|---|---|---|---|---|
| 1 | InterUniMode_0 | InterUniMode_1 | InterBiMode_0 | InterBiMode_1 |
| 2 | IntraMode_0 | IntraMode_0_C | IntraMode_1 | IntraMode_1_C |
| 3 | AffineMode_0 | AffineMode_1 | AffineMode_2 | AffineMode_3 |
| 4 | MMVD_0 | MMVD_1 | MMVD_2 | MMVD_3 |
| 5 | GEO_0 | GEO_1 | GEO_2 | GEO_3 |
| 6 | InterMergeMode_0 | InterMergeMode_1 | InterMergeMode_2 | InterMergeMode_3 |

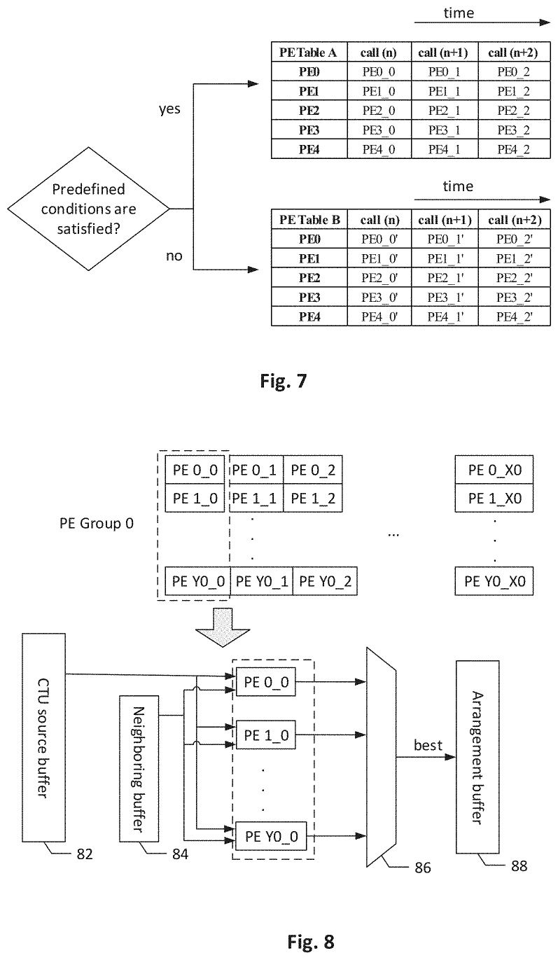

Method 2: Adaptive Coding Modes for PE Thread In some embodiments of the hierarchical architecture, coding modes associated with one or more PE threads in a PE group are adaptively selected according to one or more predefined conditions. Some embodiments of the predefined condition is associated with comparisons of information between the current partition/sub-partition and one or more neighboring blocks of the current partition/sub-partition, the current temporal layer ID, historical MV list, or preprocessing results. For example, the preprocessing results may correspond to the search result of the IME stage. In some embodiments, a predefined condition relates to the comparisons between coding modes, block sizes, block partition types, motion vectors, reconstruction samples, residuals or coefficients of the current partition/sub-partition and one or more neighboring blocks. For example, a predefined condition is satisfied when a number of neighboring blocks coded in an intra mode is greater than or equal to a threshold TH₁. In another example, a predefined condition is satisfied when the current temporal identifier is less than or equal to a threshold TH₂. According to Method 2, one or more predefined conditions are checked to adaptively select coding modes for PEs in a PE group. Pre-specified coding modes are evaluated by the PEs when the one or more predefined conditions are satisfied, otherwise, default coding modes are evaluated by the PEs. In one embodiment of adaptively selecting coding modes for a current partition, a predefined condition is satisfied when any neighboring block of the current partition is coded by an intra mode, a PE table having more intra modes is tested on the current partition if at least one neighboring block is coded in an intra mode; otherwise, a PE table having less or none intra mode is tested on the current partition. FIG. 7 illustrates an example of adaptively selecting one of two PE tables containing different coding modes according to predefined conditions. PEs 0 to 4 evaluate the coding modes in PE Table A if the predefined conditions are satisfied; otherwise, PEs 0 to 4 evaluate the coding modes in PE Table B. In FIG. 7, n is an integer greater than or equal to 0. Three calls in each PE thread being adaptively selected according to the predefined conditions in the example shown in FIG. 7, however, more or less calls in one or more PE threads may be adaptively selected according to one or more predefined conditions in other examples. The coding modes may also be adaptively switched between calls. For example, in cases when a rate distortion cost computed at call(n) by a PE is too high for a particular mode, a next PE call call(n+1) in the PE thread adaptively runs another mode or simply the next PE call(n+1) skips coding.

Method 3: Buffers Shared Among PEs of Same PE Group In some embodiments of the hierarchical architecture, certain buffers may be shared among PEs inside the same PE group by unifying a data scanning order among PE threads. For example, the sharing buffers are one or a combination of the source sample buffer, neighboring reconstruction samples buffer, neighboring motion vectors buffer, and neighboring side information buffer. By unifying the source samples loading method among PE threads with a particular scanning order, only one set of source sample buffer is required to be shared with all PEs in the same PE group. After finishing coding of each PE in a current PE group, each PE outputs final coding results to a reconstruction buffer, coefficient buffer, side information buffer, and updated neighboring buffer, and the video encoder compares the rate-distortion costs to decide the best coding result for the current PE group. FIG. 8 illustrates an example of sharing a source buffer and a neighboring buffer among PEs of PE group 0. The CTU Source Buffer 82 and the Neighboring Buffer 84 are shared between PE 0 to PE Y0 in PE group 0 by unifying the data scanning order among the PE threads. In the first call, each PE in PE group 0 such as PEs PE0_0, PE1_0, PE2_0, . . . , and PEY0_0 encode a current partition or sub-partition by assigned coding modes, and then a best coding mode is selected for the current partition/sub-partition by the multiplexer 86 according to the rate-distortion costs. Corresponding coding results of the best coding mode such as the reconstruction samples, coefficients, modes, MVs, and neighboring information are stored in the Arrangement Buffer 88.

Hardware Sharing in Parallel PEs for GPM A current coding block coded in GPM is split into two parts by a geometrically located straight line, and each part of the geometric partition in the current coding block is inter-predicted using its own motion. The candidate list for GPM is derived directly from the Merge candidate list, for example, six GPM candidates are derived from Merge candidates 0 and 1, Merge candidates 1 and 2, Merge candidates 0 and 2, Merge candidates 3 and 4, Merge candidates 4 and 5, and Merge candidates 3 and 5 respectively. After obtaining corresponding Merge prediction samples for each part of the geometric partition according to two Merge candidates, the Merge prediction samples around the geometric partition edge are blended to derive GPM prediction samples. In the conventional hardware design for computing GPM prediction samples, addition buffer resources are required to store Merge prediction samples. With the parallel PE thread design, an embodiment of a GPM PE shares the Merge prediction samples from two or more Merge PEs directly without temporary storing the Merge prediction samples in a buffer. A benefit of this parallel PE design with hardware sharing is to save the bandwidth, this benefit is achieved because GPM PEs directly use the Merge prediction samples from Merge PEs to do GPM arithmetic calculation instead of fetching reference samples from the buffer. Some other benefits of directly passing predictors from Merge PEs to GPM PEs include reducing the circuits in GPM PEs and saving the Motion Compensation (MC) buffers for GPM PEs. FIG. 9 illustrates an example of the parallel PE design with hardware sharing for Merge and GPM coding tools. In this example, GPM0 tested by PE 4 requires Merge prediction samples of Merge candidates 0, 1, and 2 for generating GPM prediction samples, it shares the Merge prediction samples of Merge candidates 0, 1, and 2 from PEs 1, 2, and 3 respectively. Similarly, GPM1 tested by PE 4 requires Merge prediction samples of Merge candidates 3, 4, and 5 for generating GPM prediction samples, so PE 4 shares the Merge prediction samples of Merge candidates 3, 4, and 5 from PEs 1, 2, and 3 respectively.

With the parallel PE design, an embodiment adaptively skips the tasks assigned to one or more remaining GPM candidates according to the rate-distortion cost of a current GPM candidate when two or more GPM candidates are tested. The PE call originally assigned for the remaining GPM candidates may be reassigned to do some other tasks or may be idle. The order of the Merge candidates is first sorted by the bits required by the Motion Vector Difference (MVD) from best to worse (i.e. from the least MVD bits to the most MVD bits). For examples, one or more GPM candidates combining the Merge candidates associating with fewer MVD bits are tested in the first PE call. If the rate-distortion cost computed in the first PE call is greater than a current best rate-distortion cost of another coding tool, then GPM tasks of the remaining GPM candidates are skipped. It is based on the assumption that the GPM candidate combining the Merge candidates associated with the least MVD bits is the best GPM candidate among all GPM candidates. If this best GPM candidate cannot generate a better predictor compared to the predictor generated by another coding tool, other GPM candidates are not worth to try. In the example as shown in FIG. 9, the bits required by the MVDs of Merge candidates Merge0, Merge1, and Merge2 are less than the bits required by the MVDs of Merge candidates Merge3, Merge4, and Merge5; GPM0 requires Merge0, Merge1, and Merge2 prediction samples and GPM1 requires Merge3, Merge4, and Merge5 prediction samples. In cases when the rate-distortion cost of GPM0 is worse than the current best rate-distortion cost, the original task assigned to do GPM1 is skipped. In some other embodiments, the Merge candidates are sorted by Sum of Absolute Transformed Difference (SATD) or Sum of Absolute Difference (SAD) between the current source samples and prediction samples. The SATD or SAD may be computed before starting of PE threads 1 to 4 by only calculating the prediction samples at some particular locations in the block partition. Since the MV of each Merge candidate is known, prediction samples at some particular locations may be estimated to derive the distortion values. For example, a current partition has 64×64 samples, before proceeding PE threads 1 to 4, prediction values of every 8^{th} sample points are estimated, so a total of (64/8)×(64/8)=64 prediction samples are collected. The SATD or SAD of these 64 sample points of the current partition can be calculated. The Merge candidates are sorted according to the SATD or SAD with the Merge candidates having lower SATD or SAD to be first used in the GPM derivation.

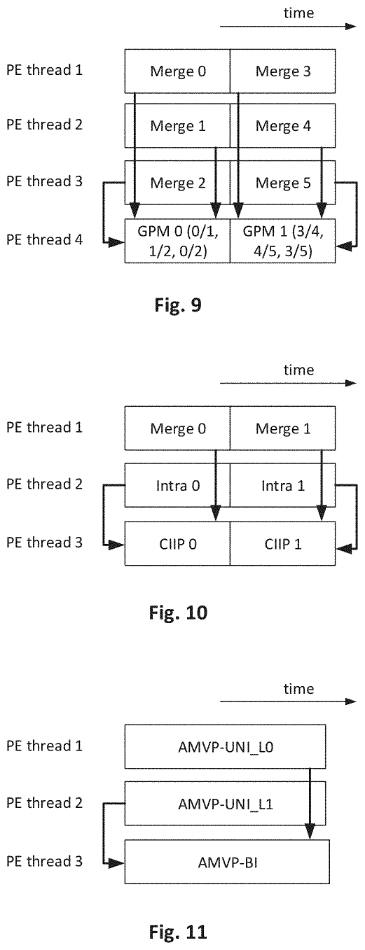

Hardware Sharing in Parallel PEs for CIP A current block coded in CIIP is predicted by combining inter prediction samples and intra prediction samples. The inter prediction samples are derived based on the inter prediction process using a Merge candidate and the intra prediction samples are derived based on the intra prediction process with the Planar mode. The intra and inter prediction samples are combined using weighted averaging, where the weight value is calculated depending on the coding modes of the top and left neighbouring blocks. With the parallel PE thread design according to an embodiment as shown in FIG. 10, a CIIP candidate tested in PE thread 3 shares prediction samples directly from an intra candidate in PE thread 2 and a Merge candidate in PE thread 1. Conventional methods of CIP encoding need to fetch reference pixels again or retrieve Merge and intra prediction samples stored in a buffer. In comparison to the conventional methods, the embodiment as shown in FIG. 10 saves the bandwidth as the prediction samples are directly passed from PE 1 and PE 2 to PE 3, reduces the circuits in the PEs testing CIIP candidates, and saves the MC buffers for these PEs. In FIG. 10, the first CIIP candidate (CIIP0) requires the first Merge candidate (Merge0) and the first intra Planar mode (Intra0) prediction samples, and second CIIP candidate (CIIP1) requires the second Merge candidate (Merge1) and the second intra Planar mode (Intra1) prediction samples. The prediction samples in PEs computing Merge0 and Intra0 are shared with the PE computing CIIP0 and the prediction samples in PEs computing Merge1 and Intra1 are shared with the PE computing CIIP1. The first intra Planar mode (Intra0) and the second intra Planar mode (Intra1) are actually the same, the embodiment as shown in FIG. 10 does not have sufficient prediction buffer for buffering the intra prediction samples of the current block partition, so Intra1 PE has to generate prediction samples by Planar mode again. In another embodiment where the capacity of the prediction buffer is enough, an additional PE call for Intra1 is not needed as the prediction samples generated by Intra0 can be buffered and later used to combine with Merge1 by the PE computing CIIP1.

With the parallel PE design, the tasks in one or more PE computing CIIP candidates can adaptively skip some CIIP candidates according to the rate-distortion performance of the prediction result generated by a previous CIIP candidate in the same PE thread. In one embodiment, if there are two or more CIIP candidates tested in a PE thread, by sorting the Merge candidates in order from the best (e.g. least MVD bits, lowest SATD, or lowest SAD) to the worse (e.g. most MVD bits, highest SATD, or highest SAD), original assigned tasks for the subsequent CIIP candidates are skipped when the rate-distortion cost associated with a current CIIP candidate is greater than the current best cost. For example, the first Merge candidate (Merge0) has a lower SAD than the second Merge candidate (Merge1), if the rate-distortion performance of the first CIIP candidate (CIIP0) is worse than the current best rate-distortion performance of another coding tool, then the second CIIP candidate (CIIP1) is skipped. It is because there is a high probability that the rate-distortion performance of the second CIIP candidate is worse than that of the first CIIP candidate if the Merge candidates is correctly sorted.

Hardware Sharing in Parallel PEs for AMVP-BI A current block coded in Bi-directional Advance Motion Vector Prediction (AMVP-BI) is predicted by combining uni-directional prediction samples from AMVP List 0 (L0) and List 1 (L1). With the parallel PE design according to an embodiment as shown in FIG. 11, an AMVP-BI candidate tested in PE thread 3 shares prediction samples directly from AMVP-UNI_L0 candidate tested in PE thread 1 and AMVP-UNI_L1 candidate tested in PE thread 2. Conventional methods of AMVP-BI encoding fetch reference pixels stored in a buffer. In comparison to the conventional methods, the embodiment as shown in FIG. 11 saves the bandwidth as the prediction samples are directly passed from PE 1 and PE 2 to PE 3, which effectively reduces the circuits in the PEs testing AMVP-BI and saves the MC buffers for these PEs. In FIG. 11, the PE computing AMVP-BI requires the List 0 uni-directional AMVP and List 1 uni-directional AMVP prediction samples. The prediction samples in PEs computing AMVP-UNI_L0 and AMVP-UNI_L1 are shared with the PE computing AMVP-BI.

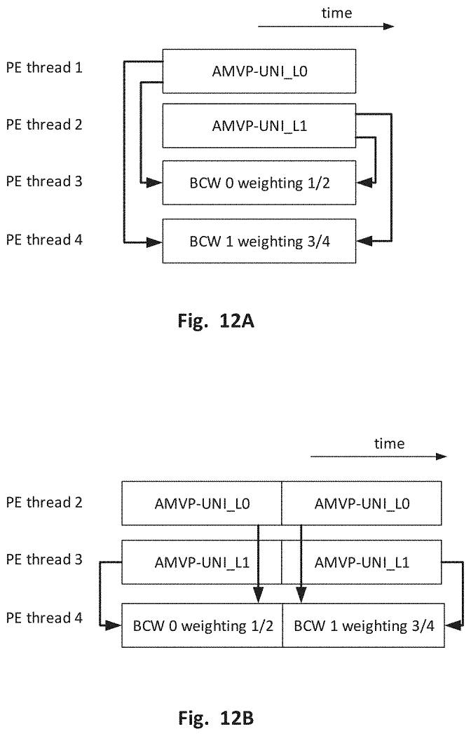

Hardware Sharing in Parallel PEs for BCW A predictor of a current block coded in BCW is generated by weighted averaging of two uni-directional prediction signals obtained from two different reference lists L0 and L1. With the parallel PE design according to an embodiment as shown in FIG. 12A, BCW0 tested in PE thread 3 and BCW1 tested in PE thread 4 share prediction samples directly from PE thread 1 testing AMVP-UNI_L0 and PE thread 2 testing AMVP-UNI_L1. Conventional methods of BCW encoding need to fetch reference pixels stored in a buffer. In comparison to the conventional methods, the embodiment as shown in FIG. 12A saves the bandwidth as the prediction samples are directly passed from PE 1 and PE 2 to PE 3 and PE 4, which reduces the circuits in PEs computing BCW0 and BCW1 and saves the MC buffers for these PEs. In FIG. 12A, the PE testing BCW0 acquires the List 0 uni-directional AMVP and List 1 uni-directional AMVP prediction samples, then tests the combinations of these two predictors by weighted averaging the prediction samples according to weight mode 1 and 2. The PE testing BCW1 also acquires the List 0 uni-directional AMVP and List 1 uni-directional AMVP prediction samples, then tests the combinations of these two predictors by weighted averaging the prediction samples according to weight mode 3 and 4. The prediction samples in PEs testing AMVP-UNI_L0 and AMVP-UNI_L1 are shared with the PE testing BCW0. FIG. 12B shows another embodiment of the parallel PE design, instead of assigning two PE to test the rate-distortion performance of BCW, only one PE is used. A benefit of this design compared to FIG. 12A is a second BCW candidate (i.e. BCW1) may be skipped according to the rate-distortion cost of a first BCW candidate (i.e. BCW0). Similar to the embodiment of parallel PE design for GPM and CIIP, if the rate-distortion cost of a current BCW candidate is greater than a current best rate-distortion cost, then the remaining BCW candidates are skipped. For example, as shown in FIG. 12B, if the PE testing BCW0 combines AMVP L0 and AMVP L1 uni-directional prediction samples with weight mode 1 and 2, and the rate-distortion costs of these two combinations are all worse than the current best rate-distortion cost, BCW1 candidate is skipped. It is assumed that predictors generated according to weight mode 1 and 2 will be better than predictors generated according to weight mode 3 and 4.

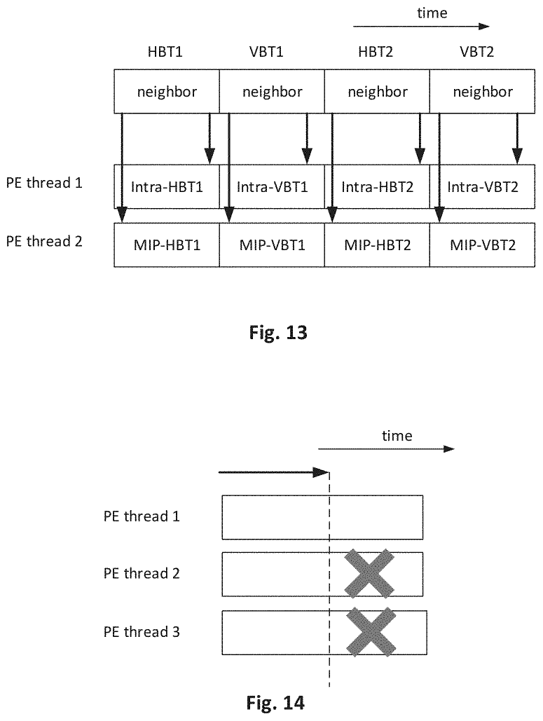

Neighboring Sharing in Parallel PEs With the parallel PE design, the buffer of neighboring reconstruction samples can be shared between different PEs according to an embodiment of the present invention. For example, only one set of neighbor buffer is needed as intra PEs and Matrix-based Intra Prediction (MIP) PEs can both acquire neighboring reconstruction samples from this shared buffer. As shown in FIG. 13, PE 1 test intra prediction while PE 2 test MIP prediction. The block partitioning testing order is horizontal binary-tree partition 1 (HBT1), vertical binary-tree partition 1 (VBT1), horizontal binary-tree partition 2 (HBT2), and vertical binary-tree partition 2 (VBT2). The first PE call in PE thread 1 and the first PE call in PE thread 2 both require neighboring reconstruction samples of the horizontal binary-tree partition 1 to derive prediction samples. With the parallel PE design, the set of neighboring buffer can be shared for these two PEs. Similarly, the second PE call in PE thread 1 and the second PE call in PE thread 2 both require neighboring reconstruction samples of the vertical binary-tree partition 1 to derive prediction samples, so the neighboring buffer pass corresponding neighboring reconstruction samples to these two PEs.

On-the-Fly Terminate Processing of Other PEs In some embodiments of the multiple PE design, the remaining processing of at least one other PE thread is early terminated according to accumulated rate-distortion costs of the parallel PEs. For example, if a current accumulated rate-distortion cost of a PE thread is much better than other PE threads (i.e. the current accumulated rate-distortion cost is much lower than each of the accumulated rate-distortion costs of other PE threads), the remaining processing of other PE threads is early terminated for power saving. FIG. 14 demonstrates an example of early terminating two of the parallel PE threads according to the accumulated rate-distortion costs of the three parallel PE threads. In this example, at a point of time before completing the coding processing tested by the parallel PEs, if the accumulated rate-distortion cost of PE thread 1 is much lower than that of PE threads 2 and 3, the video encoding early turns off the remaining processing of PE threads 2 and 3. For example, differences between the accumulated rate-distortion costs of PE thread 1 and each of PE threads 2 and 3 are greater than a predefined threshold. It is assumed that the final rate-distortion costs of PE threads 2 and 3 will definitely exceed the final rate-distortion cost of PE thread 1 when a difference between the accumulated rate-distortion costs of PE threads 1 and 2 and a difference between the accumulated rate-distortion costs of PE thread 1 and 3 both exceed a threshold at a checking time point.

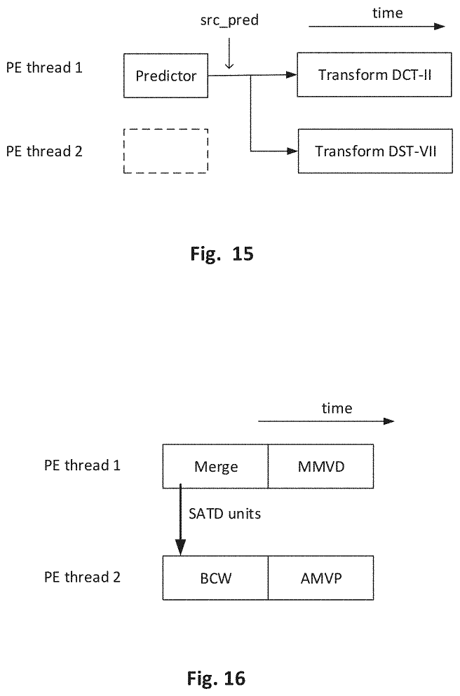

MTS Sharing for Parallel PE Architecture A Multiple Transform Selection (MTS) scheme processes residual with multiple selected transforms. For example, the different transforms include DCT-II, DCT-VIII, and DST-VII. FIG. 15 illustrates an embodiment of residual sharing for transform coding accomplished by the parallel PE design. In FIG. 15, in order to test same prediction with two different transform coding settings DCT-II and DST-VII, one PE could share its residual to another PE by the parallel PE design. The hardware benefit of only having a single residual buffer is realized by sharing the residual to both DCT-II and DST-VII transform coding. In FIG. 15, the circuits associated with the prediction processing in PE 2 can be saved as the residual generated from the same predictor can be directly passed from PE 1.

Low Complexity SATD on-the-fly Re-allocation With the parallel PE design, SATD units could be shared among parallel PEs. FIG. 16 illustrates an embodiment of sharing SATD units from one PE to another PE. In this embodiment, PE 1 encodes a current block partition by a Merge mode at a first PE call, then encodes the current or a subsequent block partition by a MMVD mode. PE 2 encodes the current block partition by a BCW mode at a first PE call and encodes the current or a subsequent block partition by an AMVP mode at a second PE call. It is assumed that Merge, BCW, MMVD, and AMVP PEs require 2, 90, 50, and 50 sets of SATD units respectively, PE 2 computing a BCW candidate may borrow 40 sets of SATD units from PE 1 computing a Merge candidate. By allowing on-the-fly re-allocation of SATD units between parallel PEs, the low-complexity rate-distortion optimization decision circuit is more efficiently used.

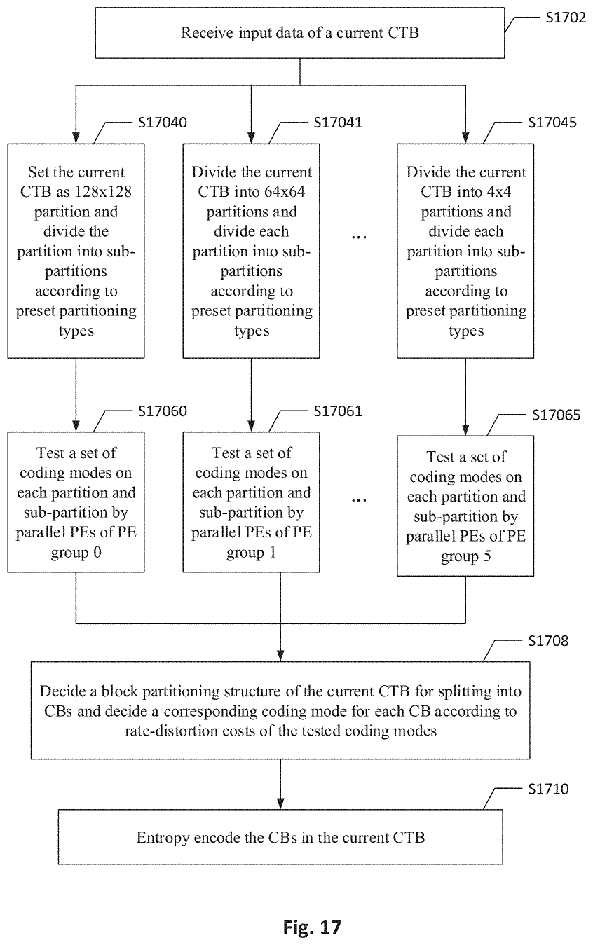

Representative Flowchart for High Throughput Video Encoding FIG. 17 is a flowchart illustrating an embodiment of a video encoding system encoding video data by a hierarchical architecture with PE groups having parallel PEs. In step S1702, the video encoding system receives a current Coding Tree Block (CTB) in a current video picture, and the current CTB is a luma CTB having 128×128 samples according to this embodiment. The maximum size for a Coding Block (CB) is set to be 128×128 and the minimum size for a CB is set to be 2×4 or 4×2 in this embodiment. Each of steps S17040, S17041, S17042, S17043, S17044, and S17045 corresponds to PE group 0, PE group 1, PE group 2, PE group 3, PE group 4, or PE group 5 respectively. PE group 0 is associated with a particular block size 128×128, and PE group 1, 2, 3, 4, or 5 is associated with a particular block size 64×64, 32×32, 16×16, 8×8, or 4×4. For PE group 0, the current CTB is set as one 128×128 partition and is divided into sub-partitions according to preset partitioning types in step S17040. For example, the preset partitioning types are horizontal binary-tree partitioning and vertical binary-tree partitioning, therefore the current CTB is divided into two 128×64 sub-partitions according to horizontal binary-tree partitioning and the current CTB is divided into two 64×128 sub-partitions according to vertical binary-tree partitioning. For PE group 1, the current CTB is first divided into four 64×64 partitions, and each 64×64 partition is divided into sub-partitions according to preset partitioning types in step S17041. Similar processing steps are carried out for PE group 2 to PE group 4 to divide the current CTB into partitions and sub-partitions, these steps are not shown in FIG. 17 for brevity. For PE group 5, the current CTB is divided into 4×4 partitions, and each 4×4 partition is divided into sub-partitions according to preset partitioning types in step S17045. There are multiple parallel PEs in each PE group. In step S17060, the PEs in PE group 0 test a set of coding modes on the 128×128 partition and on each sub-partition. In step S17061, the PEs in PE group 1 test a set of coding modes on each 64×64 partition and on each sub-partition. The PEs in PE group 2, 3, or 4 also test a set of coding modes on each corresponding partition and sub-partition. In step S17065, the PEs in PE group 5 test a set of coding modes on each 4×4 partition and sub-partition. In step S1708, the video encoding system decides a block partitioning structure of the current CTB for splitting into CBs and the video encoding system also decides a corresponding coding mode for each CB according to rate-distortion costs of the tested coding modes. The video encoding system performs entropy encoding on the CBs in the current CTB in step S1710.

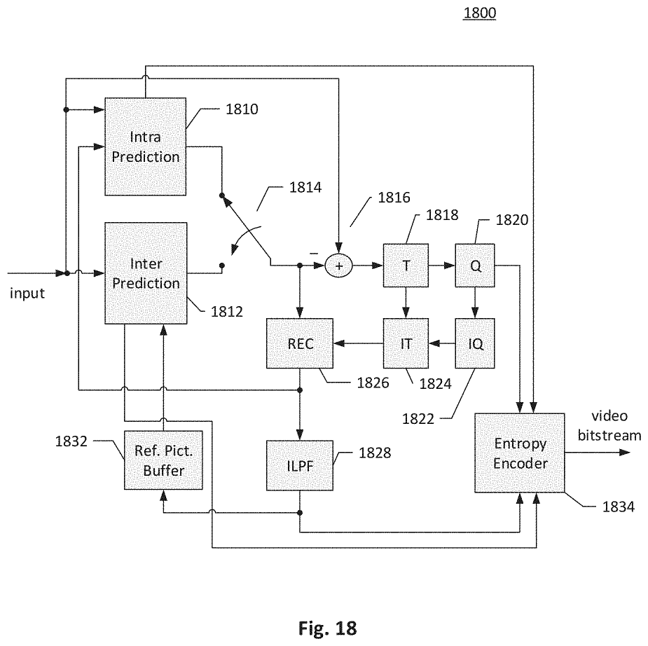

Exemplary Video Encoder Implementing Present Invention Embodiments of the present invention may be implemented in video encoders. For example, the disclosed methods may be implemented in one or a combination of an entropy encoding module, an Inter, Intra, or prediction module, and a transform module of a video encoder. Alternatively, any of the disclosed methods may be implemented as a circuit coupled to the entropy encoding module, the Inter, Intra, or prediction module, and the transform module of the video encoder, so as to provide the information needed by any of the modules. FIG. 18 illustrates an exemplary system block diagram for a Video Encoder 1800 implementing one or more of the various embodiments of the present invention. The video Encoder 1800 receives input video data of a current picture composed of multiple CTUs. Each CTU consists of one CTB of luma samples together with one or more corresponding CTB of chroma samples. A hierarchical architecture is used in the RDO stage to processes each CTB by multiple PE groups consisting of parallel processing PEs. The PEs process each CTB in parallel to test various coding modes on different block sizes. For example, each PE group is associated with a particular block size and PE threads in each PE group compute rate-distortion rates for applying various coding modes on partitions with the particular block size and corresponding sub-partitions. A best block partitioning structure for splitting the CTB into CBs and a best coding mode for each CB are determined according to a lowest combined rate-distortion rate. In some embodiments of the present invention, hardware is shared between parallel PEs within a PE group in order to reduce the bandwidth, circuits, or buffers required for encoding. For example, prediction samples are directly shared between the parallel PEs without temporary storing the prediction samples in a buffer. In another example, a set of neighboring buffer storing neighboring reconstruction samples is shared between the parallel PE threads in a PE group. In yet another example, SATD units can be dynamically shared among the parallel PE threads in a PE group. In FIG. 18, an Intra Prediction module 1810 provides intra predictors based on reconstructed video data of the current picture. An Inter Prediction module 1812 performs Motion Estimation (ME) and Motion Compensation (MC) to provide inter predictors based on referencing video data from other picture or pictures. Either the Intra Prediction module 1810 or Inter Prediction module 1812 supplies a selected predictor of a current coding block in the current picture using a switch 1814 to an Adder 1816 to form residual by subtracting the selected predictor from original video data of the current coding block. The residual of the current coding block are further processed by a Transformation module (T) 1818 followed by a Quantization module (Q) 1820. In one example of hardware sharing, residual is shared between the parallel PE threads for transform processing according to different transform coding settings. The transformed and quantized residual is then encoded by Entropy Encoder 1834 to form a video bitstream. The transformed and quantized residual of the current block is also processed by an Inverse Quantization module (IQ) 1822 and an Inverse Transformation module (IT) 1824 to recover the prediction residual. As shown in FIG. 18, the residual is recovered by adding back to the selected predictor at a Reconstruction module (REC) 1826 to produce reconstructed video data. The reconstructed video data may be stored in a Reference Picture Buffer (Ref. Pict. Buffer) 1832 and used for prediction of other pictures. The reconstructed video data from the REC 1826 may be subject to various impairments due to the encoding processing, consequently, at least one In-loop Processing Filter (ILPF) 1828 is conditionally applied to the luma and chroma components of the reconstructed video data before storing in the Reference Picture Buffer 1832 to further enhance picture quality. A deblocking filter is an example of the ILPF 1828. Syntax elements are provided to an Entropy Encoder 1834 for incorporation into the video bitstream.

Various components of the Video Encoder 1800 in FIG. 18 may be implemented by hardware components, one or more processors configured to execute program instructions stored in a memory, or a combination of hardware and processor. For example, a processor executes program instructions to control receiving input data of a current block for video encoding. The processor is equipped with a single or multiple processing cores. In some examples, the processor executes program instructions to perform functions in some components in the Encoder 1800, and the memory electrically coupled with the processor is used to store the program instructions, information corresponding to the reconstructed images of blocks, and/or intermediate data during the encoding or decoding process. In some examples, the Video Encoder 1800 may signal information by including one or more syntax elements in a video bitstream, and a corresponding video decoder derives such information by parsing and decoding the one or more syntax elements. The memory buffer in some embodiments includes a non-transitory computer readable medium, such as a semiconductor or solid-state memory, a random access memory (RAM), a read-only memory (ROM), a hard disk, an optical disk, or other suitable storage medium. The memory buffer may also be a combination of two or more of the non-transitory computer readable mediums listed above.

Embodiments of high throughput video encoding processing methods may be implemented in a circuit integrated into a video compression chip or program code integrated into video compression software to perform the processing described above. For examples, encoding coding blocks may be realized in program code to be executed on a computer processor, a Digital Signal Processor (DSP), a microprocessor, or field programmable gate array (FPGA). These processors can be configured to perform particular tasks according to the invention, by executing machine-readable software code or firmware code that defines the particular methods embodied by the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A video encoding method for performing Rate Distortion Optimization (RDO) by a hierarchical architecture in a video encoding system, comprising:
receiving input data associated with a current block in a video picture;
determining a block partitioning structure of the current block and determining a corresponding coding mode for each coding block in the current block by a plurality of Processing Element (PE) groups, and splitting the current block into one or more coding blocks according to the block partitioning structure, wherein each PE group has multiple parallel PEs performing RDO tasks, and each PE group is associated with a particular block size, for each PE group, the current block is divided into one or more partitions each having the particular block size associated with the PE group and each partition is divided into sub-partitions according to one or more partitioning types, determining the block partitioning structure and coding modes of the current block comprises:
testing a plurality of coding modes on each partition of the current block and corresponding sub-partitions split from each partition by the parallel PEs of each PE group; and
deciding the block partitioning structure of the current block and the corresponding coding mode for each coding block in the current block according to rate-distortion costs associated with the coding modes tested by the PE groups; and
entropy encoding the one or more coding blocks in the current block according to the corresponding coding modes determined by the PE groups.

2. The method of claim 1, wherein a buffer size required for each PE group is related to the particular block size of the PE group.

3. The method of claim 2, further comprising setting a same block partitioning testing order for all PEs in the PE group, and based on rate-distortion costs associated with at least two partitioning types, a set of reconstruction buffer storing reconstruction samples associated with one of the at least two partitioning types is released for storing reconstruction samples associated with another partitioning type.

4. The method of claim 1, wherein the one or more partitioning types for dividing each partition in the current block into sub-partitions include one or a combination of horizontal binary-tree partitioning, vertical binary-tree partitioning horizontal ternary-tree partitioning, and vertical ternary-tree partitioning.

5. The method of claim 1, wherein a PE tests a coding mode or one or more candidates of a coding mode in one PE call, or a PE tests a coding mode or a candidate of a coding mode in multiple PE calls.

6. The method of claim 1, wherein a PE computes a low-complexity RDO operation followed by a high-complexity RDO operation in a PE call, or a PE computes a low-complexity RDO operation or a high-complexity RDO operation in a PE call.

7. The method of claim 1, wherein a first PE in a PE group computes a low-complexity RDO operation of a coding mode and a second PE in the same PE group computes a high-complexity RDO operation of the coding mode, wherein the low-complexity RDO operation for a subsequent partition computed by the first PE is executed in parallel processing with the high-complexity RDO operation for a current partition computed by the second PE.

8. The method of claim 1, wherein coding tools or coding modes with similar properties are combined to be tested in a same PE thread in each PE group.

9. The method of claim 1, wherein testing a plurality of coding modes on a partition or sub-partitions by parallel PEs of a PE group further comprises checking one or more predefined conditions, and adaptively selecting coding modes to be tested by at least one of the parallel PEs when the one or more predefined conditions are satisfied.

10. The method of claim 9, wherein the one or more predefined conditions are associated with comparisons of information between the partition/sub-partition and one or more neighboring blocks of the partition/sub-partition, a current temporal identifier, historical Motion Vector (MV) list, or preprocessing results; wherein the information between the partition/sub-partition and one or more neighboring blocks of the partition/sub-partition comprises coding mode, block size, block partition type, MVs, reconstruction samples, or residuals.

11. The method of claim 9, wherein one or more PEs skip coding in one or more PE calls when the one or more predefined conditions are satisfied.

12. The method of claim 11, wherein one of the predefined conditions is satisfied when an accumulated rate-distortion cost associated with one PE is higher than each of accumulated rate-distortion costs associated with other PEs by a predefined threshold.

13. The method of claim 1, wherein one or more buffers are shared among the parallel PEs of a same PE group by unifying a data scanning order among the PEs.

14. The method of claim 1, wherein a current PE of a current PE group shares prediction samples from one or more PEs of the current PE group directly without temporary storing the prediction samples in a buffer.

15. The method of claim 14, wherein the current PE tests one or more Geometric Partitioning Modes (GPM) candidates on each partition or sub-partition by acquiring the prediction samples from the one or more PEs testing Merge candidates on the partition or sub-partition.

16. The method of claim 15, wherein GPM tasks originally assigned to the current PE are adaptively skipped according to a rate-distortion cost associated with a prediction result of the current PE.

17. The method of claim 14, wherein the current PE tests one or more Combined Inter and Intra Prediction (CIIP) candidates on each partition or sub-partition by acquiring the prediction samples from one or more PEs testing Merge candidates on the partition or sub-partition and one PE testing an intra Plannar mode.

18. The method of claim 17, wherein CIIP tasks originally assigned to the current PE are adaptively skipped according to a rate-distortion cost associated with a prediction result of the current PE.

19. The method of claim 14, wherein the current PE tests one or more Bi-directional Advance Motion Vector Prediction (AMVP-BI) candidates on each partition or sub-partition by acquiring the prediction samples from the one or more PEs testing Uni-directional AMVP (AMVP-UNI) candidates on the partition or sub-partition.

20. The method of claim 19, wherein the current PE tests one or more Bi-prediction with Coding Unit (CU)-level Weight (BCW) candidates on each partition or sub-partition by acquiring the prediction samples from the one or more PEs testing Uni-directional AMVP (AMVP-UNI) candidates on the partition or sub-partition.

21. The method of claim 1, wherein a set of neighboring buffer storing neighboring reconstruction samples is shared between a plurality of PEs in one PE group.

22. The method of claim 1, further comprising generating residual of each coding block in the current block, and sharing the residual between a plurality of PEs for transform processing according to different transform coding settings.

23. The method of claim 1, wherein Sum of Absolute Transformed Difference (SATD) units are dynamically shared among the parallel PEs within one PE group.

24. An apparatus for performing Rate Distortion Optimization (RDO) by a hierarchical architecture in a video encoding system, the apparatus comprising one or more electronic circuits configured for:
receiving input data associated with a current block in a video picture;
determining a block partitioning structure of the current block and determining a corresponding coding mode for each coding block in the current block by a plurality of Processing Element (PE) groups, and splitting the current block into one or more coding blocks according to the block partitioning structure, wherein each PE group has multiple parallel PEs performing RDO tasks and each PE group is associated with a particular block size, for each PE group, the current block is divided into one or more partitions each having the particular block size associated with the PE group and each partition is divided into sub-partitions according to one or more partitioning types, determining the block partitioning structure and coding modes of the current block comprises:
testing a plurality of coding modes on each partition of the current block and corresponding sub-partitions split from each partition by the parallel PEs of each PE group; and
deciding the block partitioning structure of the current block and the corresponding coding mode for each coding block in the current block according to rate-distortion costs associated with the coding modes tested by the PE groups; and
entropy encoding the one or more coding blocks in the current block according to the corresponding coding modes determined by the PE groups.
